(19) United States
(12) Patent Application Publication
(10) Pub. No.: US 2012/0274221 A1
(43) Pub. Date: Nov. 1, 2012

(54) LED POWER SUPPLY SYSTEM

(75) Inventor: CHENG-HUANG CHEN, Tu-Cheng (TW)

(73) Assignee: HON HAI PRECISION INDUSTRY CO., LTD., Tu-Cheng (TW)

(21) Appl. No.: 13/172,867

(22) Filed: Jun. 30, 2011

(30) Foreign Application Priority Data
Apr. 27, 2011 (TW) 100114686

(51) Int. Cl. H05B 37/02

(52) U.S. Cl. 315/155; 315/149

(57) ABSTRACT

A light emitting diode (LED) power supply system includes a photoelectric conversion element, an electric energy storage element, a PWM signal output element, and an LED driving unit. The photoelectric conversion element is configured for converting solar energy into electric energy. The electric energy storage element stores the electric energy from the photoelectric conversion element. The PWM signal output element and LED driving unit are both powered by the storage element. The PWM signal output element is configured to output pulse signals of different widths based on different controls of the LED to the LED driving unit, and the LED driving unit is configured to receive and convert the pulse signals into driving signals for the LED.

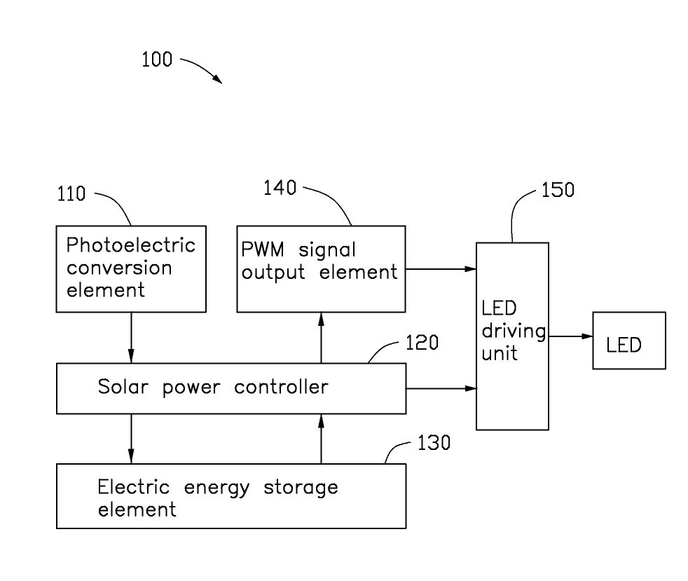

### BACKGROUND

1. Technical Field

The present disclosure relates to LED power supply systems, and particularly to a solar powered LED power supply system.

2. Description of Related Art

Solar energy has been widely used for powering various light sources, including light emitting diodes (LEDs). Current solar power supply systems for LEDs usually use a storage battery to directly power the LED. However, with this configuration, it is different to control brightness and lighting time of the LED. In addition, the voltage of the storage battery varies according to the stored energy, such that the current through the LED varies as well. In order to protect the LED, current limiting resistors have been used to limit the current going through the LED, however, these resistors consume energy of the storage battery, and brightness and lighting time of the LED still cannot be easily controlled.

What is needed, therefore, is an LED power supply system, which can overcome the above shortcomings.

### BRIEF DESCRIPTION OF THE DRAWING

Many aspects of the present LED power supply system can be better understood with reference to the following drawing. The components in the drawing are not necessarily drawn to scale, the emphasis instead being placed upon clearly illustrating the principles of the present LED power supply system.

The drawing is a block diagram of an LED power supply system in accordance with one embodiment.

### DETAILED DESCRIPTION

Embodiments of the present LED power supply system will now be described in detail below and with reference to the drawing.

Referring to the drawing, an LED power supply system 100 is shown. The system 100 includes a photoelectric conversion element 110, a solar power controller 120, an electric energy storage element 130, a pulse width modulation (PWM) signal output element 140, and an LED driving unit 150.

The photoelectric conversion element 110 includes one or more solar cells, and is configured for converting solar energy into electric energy. The electric energy storage element 130 includes one or more storage batteries.

The solar power controller 120 is configured for controlling the photoelectric element 110 to charge the electric energy storage element 130, and controlling the electric storage element 130 to power the PWM signal output element 140 and the LED driving unit 150.

The PWM signal output element 140 is configured for outputting pulse signals of different widths to the LED driving unit 150. The pulse signals are modulated according to different controls of the LED, such as brightness and lighting time on different days and in different seasons according to need. Software for generating the pulse signals can be uploaded to the PWM signal output element 140, such that the PWM signal output element 140 is capable of generating the pulse signals. Alternatively, the PWM signal output element 140 can be remotely controlled by a pulse signal generator, and the PWM signal output element 140 only transmits the pulse signals to the LED driving unit 150.

The LED driving unit 150 is configured for receiving the pulse signals output from the PWM signal output element 140, and converting the pulse signals into driving signals to the LED.

More LEDs can be applied, with their driving units 150 all controlled by the same PWM signal output element 140.

The LED driving unit 150 in cooperation with the PWM signal output element 140 can easily adjust brightness and lighting time of the LED. The LED is solar powered, which is environmentally green.

It is understood that the above-described embodiments are intended to illustrate rather than limit the disclosure. Variations may be made to the embodiments and methods without departing from the spirit of the disclosure. Accordingly, it is appropriate that the appended claims be construed broadly and in a manner consistent with the scope of the disclosure.

What is claimed is:

1. An LED power supply system, comprising:
a photoelectric conversion element configured for converting solar energy into electric energy;
an electric energy storage element storing the electric energy from the photoelectric conversion element;
a pulse width modulation signal output element and an LED driving unit both powered by the electric energy storage element, the pulse width modulation signal output element configured for outputting pulse signals of different widths based on different controls of the LED to the LED driving unit, and the LED driving unit configured for receiving and converting the pulse signals from the pulse width modulation signal output element into driving signals for the LED.

2. The LED power supply system of claim 1, further comprising a solar power controller configured for controlling the electric energy storage element to be charged by the photoelectric conversion element and to power the pulse width modulation signal output element and the LED driving unit.

3. The LED power supply system of claim 2, wherein the photoelectric conversion element comprises one or more solar cells.

4. The LED power supply system of claim 3, wherein the electric energy storage element comprises one or more storage batteries.

5. The LED power supply system of claim 1, wherein the pulse width modulation signal output element is capable of generating the pulse signals.

6. The LED power supply system of claim 1, wherein the pulse width modulation signal output element receives the pulse signals from a remote control and transmits the pulse signals to the LED driving unit.
